(19) United States
(12) Patent Application Publication
(10) Pub. No.: US 2009/0141423 A1
(43) Pub. Date: Jun. 4, 2009

(54) PARALLEL PLATE MAGNETIC CAPACITOR AND ELECTRIC ENERGY STORAGE DEVICE

(76) Inventor: James Chyi LAI, Saint Paul, MN (US)

Correspondence Address: Muncy, Geissler, Olds & Lowe, PLLC, P.O. BOX 1364, FAIRFAX, VA, 22038-1364, US

(21) Appl. No.: 12/368,670

(22) Filed: Feb. 10, 2009

Related U.S. Application Data
(63) Continuation-in-part of application No. 11/826,176, filed on Jul. 12, 2007.

(30) Foreign Application Priority Data
Jan. 12, 2009 (GB) 0900432.6

(51) Int. Cl. H01G 4/00; H01G 4/005

(52) U.S. Cl. 361/303; 361/301.1

(57) ABSTRACT

A parallel plate magnetic capacitor (Mcap) includes two first pillar electrodes, two second pillar electrodes and a dielectric layer. The two first pillar electrodes electro-connect with each other and are located at right corner of a first plane and left corner of a second plane respectively. The two second pillar electrodes electro-connect with each other and are located at left corner of the first plane and right corner of the second plane respectively. The dielectric layer is located between the first pillar electrodes and the second pillar electrodes, such that the first pillar electrodes and the second pillar electrodes form capacitances therebetween.

### RELATED APPLICATIONS

This application is a continuation-in-part of U.S. application Ser. No. 11/826,176, filed Jul. 12, 2007. The present application also claims priority to UK Application Serial Number 0900432.6, filed Jan. 12, 2009. All of these applications are incorporated herein by this reference.

### BACKGROUND

1. Field of Invention

The present invention relates to a capacitor and an electric energy storage device. More particularly, the present invention relates to a parallel plate magnetic capacitor and an electric energy storage device.

2. Description of Related Art

Conventionally, parallel plate capacitors are structured using two conductive plates with dielectric material between the plates. The capacitance of the parallel plate capacitor can be calculated using the standard equation (1) and the electric energy corresponding to the capacitance can be calculated using the standard equation (2):

$$\begin{matrix}C = \frac{{e}_{0} {e}_{k} A}{r} & ( 1 ) \\ E = \frac{1}{2} C {V}^{2} & ( 2 )\end{matrix}$$

wherein C is the capacitance of the parallel plate capacitor, e₀ is the dielectric constant of free space (8.85×10⁻¹²), eₖ is the dielectric constant of the material between the parallel plates, A is the interface area of the parallel plate, r is the distance between the parallel plates, E is the electric energy, and V is the applied voltage. Equation (1) showed that the capacitance of a parallel plate capacitor is proportional to the interface area of the parallel plate. For example, please refer to FIG. 1, a cross-section view of a conventional parallel capacitor structure. The conventional parallel capacitor 100 includes an upper conductive plate 102, a bottom conductive plate 104, and a dielectric layer 106 in between the plates 102 and 104. The width of the upper conductive plate 102 is 18 units. The depth of the upper conductive plate 102 is 2 units. Therefore, A is equal to 18×2=36 units² leading to a capacitance 108 proportional to A.

The structure of the parallel capacitor 100 mentioned above, one would have to increase the area of the parallel plates in order to increase the total capacitance of the parallel capacitor, assuming the eₖ and r stays the same. Therefore it is a trade off between capacitance and the size of the capacitor, introducing a bottleneck to increase the capacitance while keeping the size of the parallel plate capacitor the same.

For the forgoing reasons, there is a need for a new parallel plate capacitor with a new structure to increase the capacitance while maintaining the overall volume of the capacitor.

### SUMMARY

In accordance with one embodiment, a magnetic capacitor (Mcap) is provided. The magnetic capacitor includes a first conductive magnetic metal, a second conductive magnetic metal and a dielectric material. The first conductive magnetic metal has a first upper finger located on an upper plane and a first lower finger located on a lower plane, in which the first upper finger is electrically connected to the first lower finger. The second conductive magnetic metal has a second upper finger and a second lower finger electrically connected with each other. The second upper finger is located on the upper plane such that the second upper finger is next to the first upper finger to form a first interface and on top of the first lower finger to form a second interface. The second lower finger is located on the lower plane such that the second lower finger is next to the first lower finger to form a third interface and below the first upper finger to form a fourth interface. The dielectric material is located in the first interface, the second interface, the third interface, and the fourth interface.

In accordance with another embodiment, a magnetic capacitor (Mcap) is provided. The magnetic capacitor (Mcap) includes two first pillar electrodes, two second pillar electrodes and a dielectric layer. The two first pillar electrodes electro-connect with each other and are located at right corner of a first plane and left corner of a second plane respectively. The two second pillar electrodes electro-connect with each other and are located at left corner of the first plane and right corner of the second plane respectively. The dielectric layer is located between the first pillar electrodes and the second pillar electrodes, such that the first pillar electrodes and the second pillar electrodes form capacitances therebetween.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a cross section view of a conventional parallel plate capacitor;

FIG. 2 is a cross section view of a parallel plate magnetic capacitor according to one preferred embodiment of this invention; and

FIG. 3 is a top view of a parallel plate magnetic capacitor according to one preferred embodiment of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

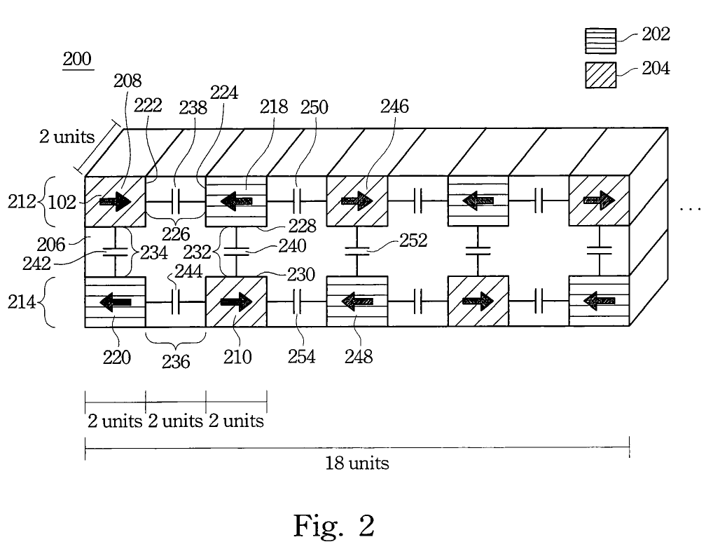

Please refer to FIG. 2, a cross section view of a parallel plate magnetic capacitor according to an embodiment of the present invention. The magnetic capacitor 200 includes a first conductive magnetic metal structure 202, a second conductive magnetic metal structure 204, and a dielectric layer 206. The first conductive magnetic metal structure is composed of a first upper finger 208 and a first lower finger 210. The first upper finger 208 is located on an upper plane 212 and the first lower finger 210 is located on a lower plane 214. The first upper finger 208 is electrically connected to the first lower finger 210. The connection may be via a conductive strip 216, which will be described later.

The second conductive magnetic metal structure 204 is composed of a second upper finger 218 and a second lower finger 220 electrically connected together. The second upper finger 218 is located on the upper plane 212 such that the second upper finger 218 is next to the first upper finger 208, which the side surface 222 of the first upper finger 208 and the side surface 224 of the second upper finger 218 forms a first interface 226. Furthermore, the second upper finger 218 is also on top of the first lower finger 210, which the bottom surface 228 of the second upper finger 218 and the top surface 230 of the first lower finger 210 forms a second interface 232.

Similarly, the second lower finger 220 is located on the lower plane 214, next to the first lower finger 210, and on below the first upper finger 208. Therefore, the second lower finger 220 forms a third interface 234 and a fourth interface 236 with the first upper finger 208 and the first lower finger 210.

The dielectric layer 206 is located between all the interfaces. Each interface 226, 232, 234, and 236 introduces a first capacitance 238, a second capacitance 240, a third capacitance 242, and a fourth capacitance 244, respectively. Therefore, the total capacitance introduced by the capacitor with the interfaces 226, 232, 234, and 236 is the sum of the capacitances 238, 240, 242, and 244. For example, if each interface introduces 4 units of capacitance, then when a voltage difference is applied between the first conductive magnetic metal structure 202 and the second conductive magnetic metal structure 204, the total capacitance introduced by the four interfaces 226, 232, 234, and 236 is 16 units.

In addition, when the first conductive magnetic metal structure 202 and the second conductive magnetic metal structure 204 are electrically biased, they would have magnetic polarization therein, in which the arrows shown in FIG. 2 indicate the magnetic polarization.

The parallel capacitor structure may be expanded further as illustrated by FIG. 2. A third upper finger 246 and a third lower finger 248 may be included in the first conductive magnetic metal structure 202 and the second conductive magnetic metal structure 204, respectively, to introduce additional capacitances 250, 252, and 254. The third upper finger 246 is located on the other side of the second upper finger 218 opposite to the first upper finger 208. The third lower finger 248 is located below the third upper finger 246. Similarly, the magnetic capacitor 200 may be expanded further according to the same pattern, where all the fingers of the first conductive magnetic metal structure 202 are electrically connected with each other. All the fingers of the second conductive magnetic metal structure 204 are electrically connected with each other.

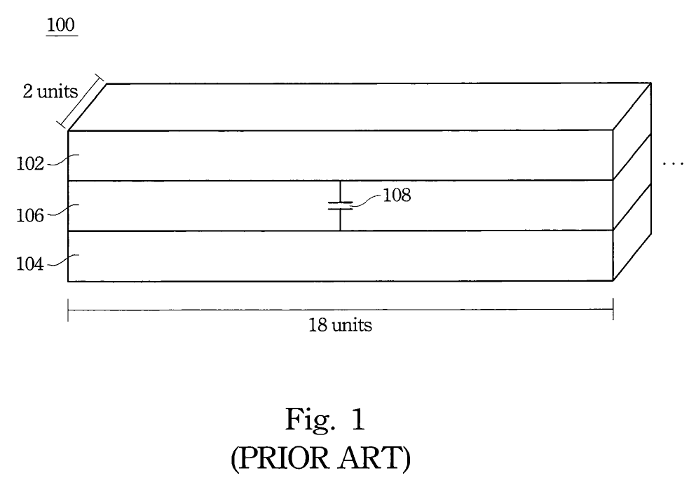

In order to illustrate that for the two parallel plate capacitors with the same dimension, namely capacitor 100 and capacitor 200, capacitor 200 introduces more capacitance than capacitor 100. Assuming the first upper finger 208 has a dimension of 2×2 (width=2 units, depth=2 units) and each finger in capacitor 200 has the same dimension. Therefore, the first capacitance 238 is proportional to 4 units² and all other capacitances (capacitances 240, 242, 244 . . . etc) have values of 4 units². Thus in FIG. 2, assuming the distance between the fingers are also 2 units, a total of 13 4 units² capacitances are introduced in a 18 unit wide, 2 unit deep magnetic capacitor 200. The sum of the 13 capacitances equaled to be 52 units² of total capacitance. Compared this result with the 36 units² of capacitance in the parallel plate capacitor 100 shown in FIG. 1, the capacitance in the magnetic capacitor 200 is almost 1.5 times the capacitance in the capacitor 100, an increase of almost 50%. Furthermore, more dielectric material is available and the dielectric constant thereof is also increased in the order of magnitude due to the magnetic effect for energy storage since the magnetic metal structures are utilized in the proposed capacitor. As a result, the capacitance of the parallel plate magnetic capacitor can be increased due to magnetic effect or so called “Colossal Magnetic Capacitance” effect. Additionally, the capacitance of the parallel plate magnetic capacitor can be calculated using the equation (a) as follows:

$$C = \frac{{e}_{0} {e}_{k} {e}_{C M C} A}{r} \qquad ( a )$$

where e_{CMC} is the coefficient due to Colossal Magnetic Capacitance effect

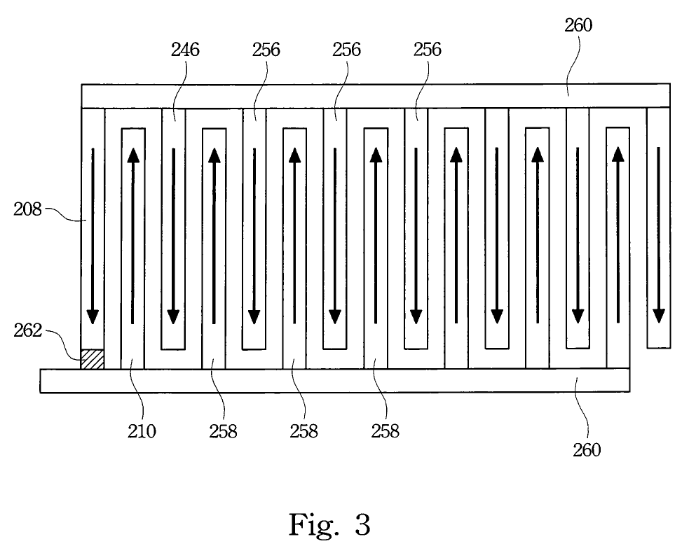

Please refer to FIG. 3, a parallel plate magnetic capacitor according to one preferred embodiment of this invention. The first upper finger 208, the third upper finger 246, and the similarly configured upper fingers 256 are located on the upper plane 212. The first lower finger 210 and the similarly configured lower fingers 258 are located on the lower plane 214. The fingers of the first conductive magnetic metal structure on the upper plane 212 are electrically connected via a conductive strip 260 as previously mentioned. The fingers of the first conductive magnetic metal structure on the lower plane 214 are electrically connected via a conductive strip 216. From the top view of the magnetic capacitor in FIG. 3, notice the fingers on the upper plane 212 can be electrically connected to the fingers on the lower plane 214 via a short interconnect 262 on either ends of the first conductive magnetic metal structure 202. In addition, the arrows shown in FIG. 3 also indicate the magnetic polarization. From the above-described embodiment of the present invention, more capacitance is introduced within the same volume of materials as conventional parallel plate capacitors. Not only is the capacitance increased, less conductive material is needed since the fingers introduce capacitance with the fingers on different planes and adjacent fingers, where as the conventional parallel plate capacitors only introduces capacitance between the planes. Thus more dielectric material is used. Therefore, the disclosed magnetic capacitor will be lighter in weight.

On the other hand, if the capacitance needed not to be increased, the volume of the capacitor can be reduced using the disclosed structure to obtain the same capacitance as a conventional parallel plate capacitor. Also, the disclosed capacitor may be expanded into multiple planes using the same structural geometry. From the above embodiment, a structural pattern can be observed. The structural pattern includes two first pillar electrodes located at opposite corners and different planes and two second pillar electrodes located on the remaining corners of the different planes. For example, if the first electrodes are located at the right corner of a first plane and the left corner of a second plane, then the second electrodes are located at the left corner of a first plane and the right corner of the second plane. A dielectric layer is located between the electrodes to form capacitances.

According to the above-mentioned structural pattern, a third plane may be added below the second plane to expand the capacitor. On the third plane, a third pillar electrode and a fourth pillar electrode are located thereon to form additional capacitances with each other and with the electrodes in the second plane.

According to the foregoing embodiments, the semiconductor material can be surrounded with magnetic layers to obtain colossal magneto capacitance where the dielectric constant of the material goes up to 10⁹. In addition, the magnetic capacitor can be provided to reduce weight, volume, and cost, and be a high valued capacitor.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A parallel plate magnetic capacitor (Mcap), comprising:
a first conductive magnetic metal having a first upper finger located on an upper plane and a first lower finger located on a lower plane, the first upper finger being electrically connected to the first lower finger;
a second conductive magnetic metal having a second upper finger and a second lower finger electrically connected with each other, the second upper finger being located on the upper plane such that the second upper finger is next to the first upper finger to form a first interface and on top of the first lower finger to form a second interface, the second lower finger being located on the lower plane such that the second lower finger is next to the first lower finger to form a third interface and below the first upper finger to form a fourth interface; and
a dielectric material located in the first interface, the second interface, the third interface, and the fourth interface.

2. The parallel plate magnetic capacitor of claim 1, wherein the first upper finger, the second upper finger, the first lower finger and the second lower finger are magnetic metal lines.

3. The parallel plate magnetic capacitor of claim 1, wherein the first interface, the second interface, the third interface and the fourth interface introduce a first capacitance, a second capacitance, a third capacitance and a fourth capacitance respectively when the first conductive magnetic metal and the second conductive magnetic metal are electrically biased having magnetic polarization.

4. The parallel plate magnetic capacitor of claim 3, wherein the first capacitance, the second capacitance, the third capacitance, and the fourth capacitance sum into a total capacitance.

5. The parallel plate magnetic capacitor of claim 1, wherein the first conductive magnetic metal further comprises a third upper finger electrically connected to the first lower finger and located on the upper plane such that the third upper finger is next to the second upper finger on the opposite side of the first upper finger, whereby forming a fifth interface.

6. The parallel plate magnetic capacitor of claim 5, wherein the fifth interface introduces a fifth capacitance.

7. The parallel plate magnetic capacitor of claim 5, the second conductive material further comprises a third lower finger electrically connected to the second upper finger and located on the lower plane such that the third lower finger is below the third upper finger to form a sixth interface.

8. The parallel plate magnetic capacitor of claim 7, wherein the sixth interface introduces a sixth capacitance.

9. A parallel plate magnetic capacitor (Mcap), comprising:
two first pillar electrodes electro-connecting with each other and located at right corner of a first plane and left corner of a second plane respectively;
two second pillar electrodes electro-connecting with each other and located at left corner of the first plane and right corner of the second plane respectively; and
a dielectric layer located between the first pillar electrodes and the second pillar electrodes, such that the first pillar electrodes and the second pillar electrodes form capacitances therebetween.

10. The parallel plate magnetic capacitor of claim 9, wherein the first pillar electrodes having a first electric potential and the second pillar electrodes having a second electric potential different from the first electric potential.

11. The parallel plate magnetic capacitor of claim 9, wherein the first plane is on top of the second plane.

12. The parallel plate magnetic capacitor of claim 9, further comprising:
a third pillar electrode located at a right corner of a third plane, such that the third plane is below the second plane; and
a fourth pillar electrode located at a left corner of the third plane.

13. The parallel plate magnetic capacitor of claim 12, wherein the third pillar electrode has the first electric potential and the fourth pillar electrode has the second electric potential.

14. The parallel plate magnetic capacitor of claim 12, wherein the dielectric layer is located between the third and fourth pillar electrode, the second and third electrode and the first and fourth electrode.
